(19) United States
(12) Patent Application Publication
(10) Pub. No.: US 2015/0075385 A1
(43) Pub. Date: Mar. 19, 2015

(54) CLEANSING DEVICE

(71) Applicants: FU DING ELECTRONICAL TECHNOLOGY (JIASHAN) CO.,LTD., Zhejiang (CN); HON HAI PRECISION INDUSTRY CO., LTD., New Taipei (TW)

(72) Inventors: XIAO-LU OU, Jiashan (CN); WEI-ZHONG DAI, Jiashan (CN)

(21) Appl. No.: 14/484,582

(22) Filed: Sep. 12, 2014

(30) Foreign Application Priority Data
Sep. 13, 2013 (CN) 2013205663098

(51) Int. Cl. B01D 46/00; B01D 47/06

(52) U.S. Cl. CPC B01D 46/0035; B01D 47/06; B01D 2201/0415; B01D 2257/702
USPC 96/322

(57) ABSTRACT

A cleansing device used to purify waste gas includes a housing having an air inlet and an exhaust vent, a filter and a spraying module positioned in the housing. The spraying module is positioned on top of the filter to spray on the filter. The cleansing device further comprises two parallel support members mounted on two opposite inner surfaces of the housing. The filter is slidably mounted on the support members to slide into or out of the housing.

### FIELD

The subject matter herein generally relates to cleansing devices, and particularly to an industrial cleansing device.

### BACKGROUND

In cutting processes, cutting fluids or cutting oils are often used to assist a cutting tool to cut workpieces, and a large amount of waste gas containing oil flag and dust can be generated. A cleansing device can purify the waste gas.

### BRIEF DESCRIPTION OF THE DRAWINGS

Implementations of the present technology will now be described, by way of example only, with reference to the attached figures.

FIG. 1 is an isometric view of an embodiment of a cleansing device.

FIG. 2 is a cross-sectional, isometric view of the cleansing device shown in FIG. 1.

FIG. 3 is an exploded isometric view of the cleansing device shown in FIG. 1.

FIG. 4 is an isometric view of the cleansing device shown in FIG. 1 from another angle.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

Several definitions that apply throughout this disclosure will now be presented.

The term “substantially” is defined to be essentially conforming to the particular dimension, shape or other word that substantially modifies, such that the component need not be exact. For example, substantially cylindrical means that the object resembles a cylinder, but can have one or more deviations from a true cylinder. The term “comprising,” when utilized, means “including, but not necessarily limited to”; it specifically indicates open-ended inclusion or membership in the so-described combination, group, series and the like.

The present disclosure is relation to a cleansing device used to purify waste gas in cutting processes.

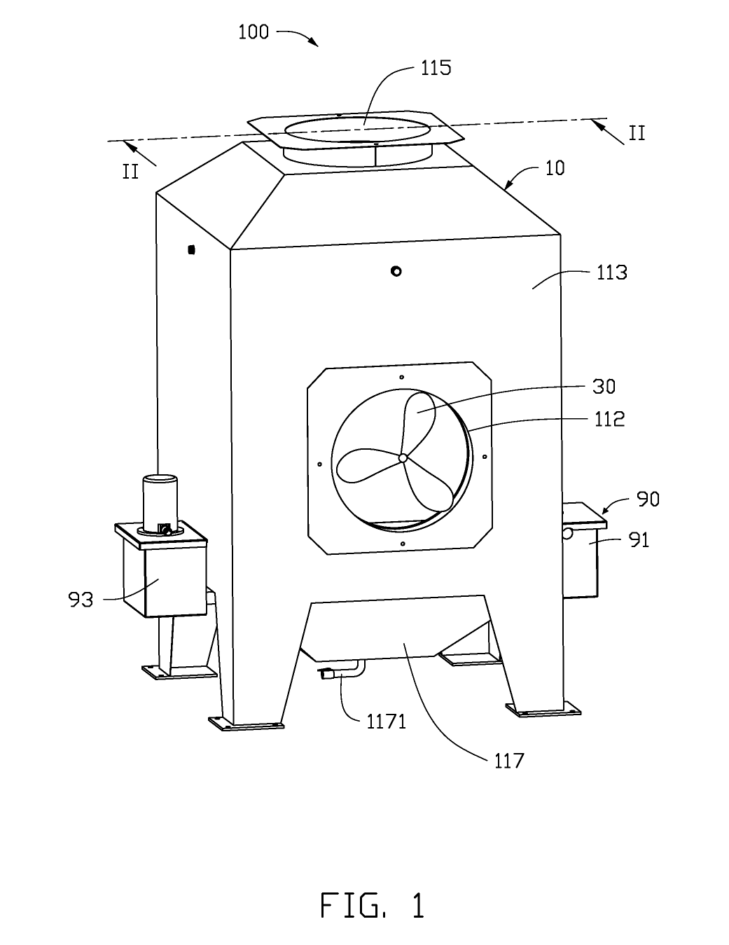

FIG. 1 illustrates a cleansing device 100 including a housing 10, a fan 30, and a circulation module 90. The fan 30 and the circulation module 90 can be mounted on the housing 10.

The housing 10 can be hollow and substantially rectangular, and define an air inlet 112 in a side wall, an exhaust vent 115 on a top surface, and a storage container 117 on a bottom surface. External waste gas flows into the cleansing device 100 through the air inlet 112, and clean gas flows out of the cleansing device 100 through the exhaust vent 115.

The storage container 117 can be positioned opposite to the exhaust vent 115 and can be substantially funnel-shaped in that the side walls slope so that the lower portion is narrower than the upper portion. The storage container 117 can be used to receive water for spraying the waste gas, and residues in the water can be gathered or collected in the storage container 117. The bottom of the storage container 117 can define a drain pipe 1171 for removing the residues in the water.

The fan 30 can be mounted on the housing 10 corresponding to the air inlet 112. The fan 30 can rotate relative to the housing 10, configured to lead the external waste gas quickly flowing into the cleansing device 100.

The circulation module 90 can include a water tank 91 and a water pump 93, which in this example are mounted on two opposite side walls of the housing 10, but can be mounted in other configurations. The circulation module 90 can supply water to the cleansing device 100.

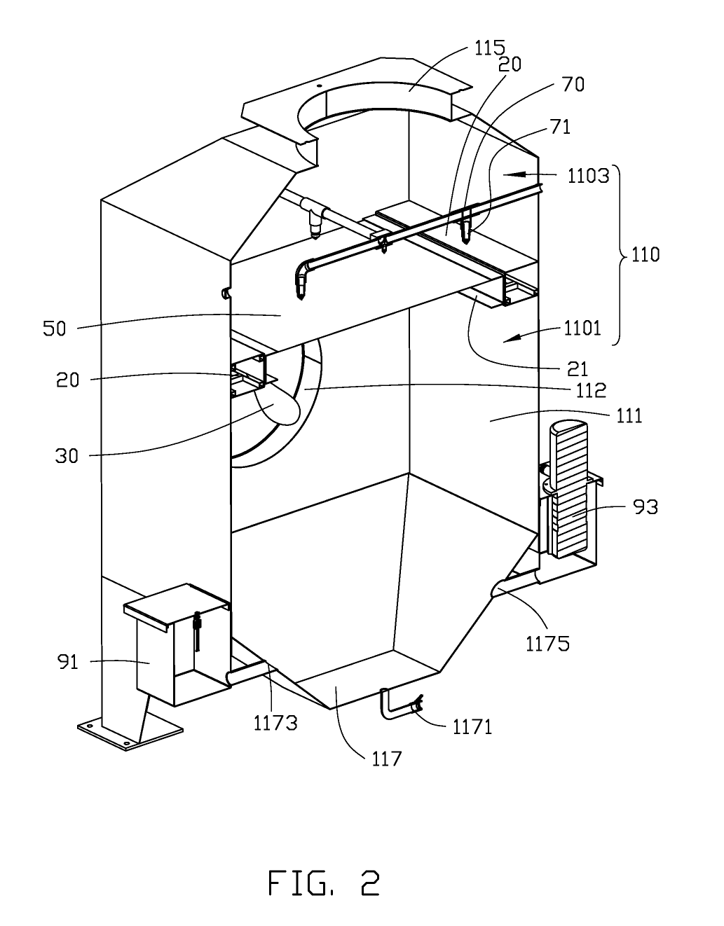

FIG. 2 illustrates that the cleansing device 100 can further include a receiving portion 110 in the housing 100, two support members 20, a filter 50, and a spraying module 70 received in the receiving portion 110.

The receiving portion 110 can be separated into a waste gas receiving portion 1101 and a fresh gas exhausting portion 1103 by the filter 50. The fan 30 can be positioned on the waste gas receiving portion 1101. The air inlet 112 and the exhaust vent 115 can be connected with the receiving portion 110.

The two support members 20 can be parallel to each other and mounted on two opposite inner surfaces 111 of the housing 10. Each support member 20 can include a guiding rail 21, and the two guiding rails 21 can face each other.

The filter 50 can filter the waste gas and oil fog in the waste gas can adsorb on the filter 50. The filter 50 can be a substantially rectangular plate and positioned on the two support members 20. Two ends of the filter 50 can be slide on the guiding rail 21, and the filter 50 can slide into or slide out of the housing 100.

The spraying module 70 can be positioned on top of the filter 50 and can include a plurality of sprayers 71 used to spray the filter 50 and form water films on the filter 50. The oil fog can condense or solidify with the water films, and then drip to the storage container 117 with the water films.

The central portion of storage container 117 can define a filler 1173 communicated to the water tank 91 and a feed water inlet 1175 communicated to the water pump 93. The water tank 91 can be connected to an external water source to supply water to the storage container 117, and the water pump 93 can pump the water to the spraying module 70. The circulation module 90 can further include a water filter (not shown) connected to the storage container 117 and the water pump 93, configured to filter the water, thus the water in the storage container 117 can be filtered and transported by the water pump 93, and then supplied to the spraying module 70. Therefore, the water in the storage container 117 can be recycled. When the residue in the water meets or exceeds a pre-determined value, the water can exit through the drain pipe 1171, and the water tank 91 can supply water to the storage container 117 from the external water source again. The filter can prevent the residue in the water from blocking up the sprayers 71.

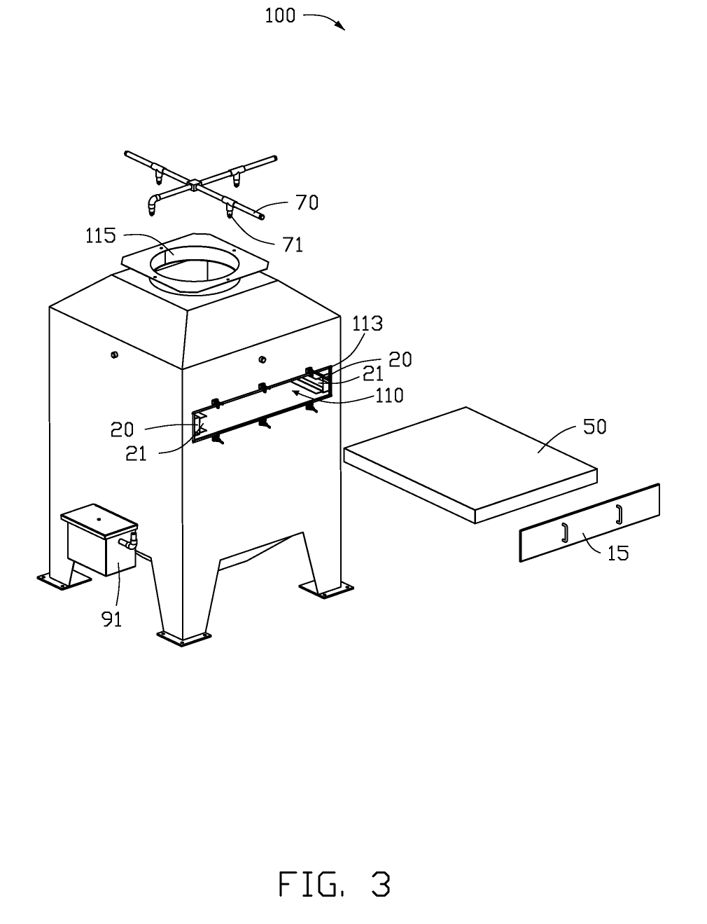

FIG. 3 illustrates that the cleansing device 100 can further include a seal cover 15 detachably mounted on the housing 10. The housing 10 can further define an assembly hole 113, the two support member 20 are positioned on two sides of the assembly hole 113. The filter 50 can be assembled in the cleansing device 100 through the assembly hole 113 and slide on the guiding rails 21 of the support members 20.

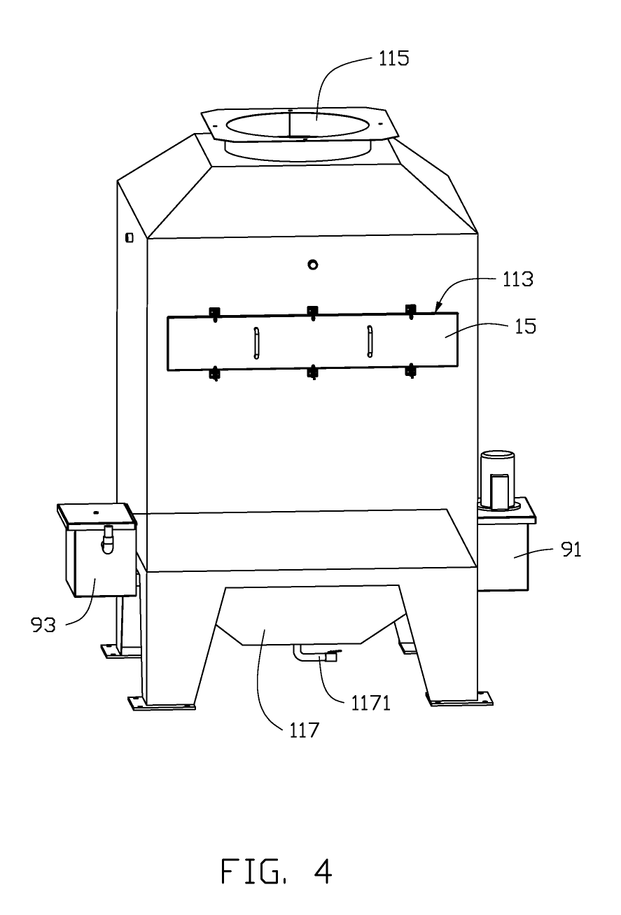

FIG. 4 illustrates that the seal cover 15 can seal the assembly hole 113 to prevent the waste gas flowing out of the assembly hole 113.

In operation, the fan 30 can rotate to lead the external waste gas into the receiving portion 110, and the water tank 91 can supply water to the storage container 117. The water in the storage container 117 can be filtered and then transported to the spraying module 70 by the water pump 93. The sprayers 71 can spray water to the filter 50 and the water films can be formed on the filter 50. The oil fog can condense or solidify and drip to the storage container 117 with the water films. The water in the storage container 117 can be filtered and transported to the spraying module 70, until the residue in the water meets or exceeds some predetermined threshold, and the water can exit through the drain pipe 1171.

When replacing the filter 50, the seal cover 15 can be detached from the housing 100, and the filter 50 can be pulled out along the guiding rails 21 of the support members 20. Then, the filter 50 can be cleaned and returned into the receiving portion 110 along the guiding rails 21 or the filter 50 can be replaced in a similar manner with a new, clean filter.

The cleansing device 100 can include two support members 20 positioned parallel in the receiving portion 110 and on two sides of the assembly hole 113, the filter 50 can be mounted on the support members 20 through the assembly hole 113. The filter 50 can slide into and out of the receiving portion 110 along the guiding rails 21 of the support members 20, so that the filter 50 can be detached more easily for convenient replacement and cleaning

In other embodiments, the fan 30 can be omitted, and the waste gas can flow into the receiving portion through the air inlet 112. The seal cover 15 can also be omitted.

In other embodiments, the circulation module 90 can be omitted, and the spraying module 70 can be directly connected to the external water source.

In other embodiments, the filter in the storage container can be omitted, and the water pump 93 can directly supply the water in the storage container 117 to the sprayer module 70.

In other embodiments, the assembly hole 113 can be omitted, and one side wall of the housing 10 can be detached and the filter 50 can then be assembled on the support members 20.

The embodiments shown and described above are only examples. Many details are often found in the art such as the other features of a cleansing device. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, comprising in matters of shape, size and arrangement of the parts within the principles of the present disclosure up to, and including the full extent established by the broad general meaning of the terms used in the claims. It will therefore be appreciated that the embodiments described above may be modified within the scope of the claims.

What is claimed is:

1. A cleansing device used to purify waste gas, comprising:
a housing having an air inlet and an exhaust vent;
a filter positioned in the housing; and
a spraying module positioned on top of the filter to spray on the filter;
wherein the cleansing device further comprises two parallel support members mounted on two opposite inner surfaces of the housing;
wherein, the filter is slidably mounted on the support members to slide into or out of the housing.

2. The cleansing device as claimed in claim 1, wherein each of the support members includes a guiding rail, and two ends of the filter are clamped into the guiding rails.

3. The cleansing device as claimed in claim 1, wherein the housing further defines an assembly hole, the two support members are positioned on two sides of the assembly hole, and the filter is assembled in the housing through the assembly hole.

4. The cleansing device as claimed in claim 3, wherein the cleansing device further includes a seal cover detachably mounted on the housing, and the seal cover seals the assembly hole to prevent the waste gas from flowing out of the assembly hole.

5. The cleansing device as claimed in claim 1, wherein the cleansing device further includes a fan mounted on the housing corresponding to the air inlet, used to lead the waste gas flowing into the housing.

6. The cleansing device as claimed in claim 1, wherein a bottom portion of the housing includes a storage container to receive the water sprayed by the spraying module.

7. The cleansing device as claimed in claim 6, wherein the storage container is substantially funnel-shaped.

8. The cleansing device as claimed in claim 6, wherein the storage container further define a drain pipe to exclude residues in the water.

9. The cleansing device as claimed in claim 6, wherein the cleansing device further includes a circulation module having a water pump; the water pump is mounted on the housing and connected to the storage container, and the water in the storage container is transported to the spraying module by the water pump.

10. The cleansing device as claimed in claim 9, wherein the circulation module further includes a water tank mounted on the housing and connected to the storage container, and the water tank is used to supply water to the storage container.

11. The cleansing device as claimed in claim 10, wherein the circulation module further includes a filler communicated to the water tank and a feed water inlet communicated to the water pump.
